(19) United States
(12) Patent Application Publication
(10) Pub. No.: US 2004/0168101 A1
(43) Pub. Date: Aug. 26, 2004

(54) Redundant memory system and memory controller used therefor

(76) Inventor: Atsushi Kubo, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/409,580

(22) Filed: Apr. 9, 2003

(30) Foreign Application Priority Data
Apr. 9, 2002 (JP) 106467/2002

(51) Int. Cl. G06F 11/00

(52) U.S. Cl. 714/6

(57) ABSTRACT

A redundant memory system makes it possible to replace a failed one of memory modules incorporated with a new memory sub-module during the energized or in-service state even if the OS used in a system does not support the memory redundancy function. This memory system includes memory modules inserted into respective slots, and a memory controller connected to the slots and providing redundancy. The controller defines one of the modules as a parity memory and its remainder as data memories. A first parity code is generated from desired data to be stored and written into the parity memory while the desired data are written into the respective data memories. The desired data are read from the respective data memories and the first parity code is read from the parity memory to thereby conduct a parity check operation and an error correction operation of the desired data using the desired data and the first parity code, resulting in the redundancy.

### BACKGROUND OF THE INVENTION

1. Field of the Invention

The present invention relates to a redundant memory system and a memory controller used therefore. More particularly, the invention relates to a redundant memory system including a plurality of memory modules, such as a Redundant Array of Independent Memory Modules (RAIMM), and a memory controller used for controlling the memory system. The modules are typically in the form of the Dual Inline Memory Module (DIMM) or Single Inline Memory Module (SIMM).

2. Description of the Related Art

Conventionally, to make it possible to realize continuous operation of a computer system in spite of the failure of memories, various memory control techniques have ever been developed and used. Typical examples of the techniques are the Error Checking and Correction (ECC) technique and the ChipKill technique. The ECC technique is a well-known technique to check and correct errors using a parity code. The ChipKill technique, which is disclosed, for example, in the Japanese Non-Examined Patent Publication No. 2001-142789 published in May 25, 2001, is a technique to avoid the use of the data read out from a failed memory element.

For example, the Japanese Non-Examined Patent Publication No. 5-128012 published in May 25, 1993 discloses an electronic disk apparatus. This electronic disk apparatus comprises M memory packages for each storing data of (N×M) bits/word, where N and M are positive integers; a memory power supply circuit for controlling the turn-on and turn-off of power supplied to the respective M memory packages; control means for reading data from a new memory package word by word in response to the turn-on operation of the memory power supply circuit with respect to the new memory package after replacement; and error correction means for correcting an error of at least N bits about the data thus read from the new memory package. This apparatus makes it possible to reconstitute the data at high speed using the error correction function.

The Japanese Non-Examined Patent Publication No. 10-111839 published in Apr. 28, 1998 discloses a memory circuit module. This memory circuit module comprises a data memory section for storing data; an ECO memory section for storing an error correction code of data stored in the data memory section; an error correction code generation section for generating an error correction code for data; and an error-correction/detection section for detecting and correcting errors using the error correction code stored in the ECC memory section. This module makes it possible to detect and correct ECC errors.

With the above-described conventional techniques, obtainable fault tolerance with respect to the memory is improved by the ECC or ChipKill technique. However, the following problems still exist:

The first problem is that if the operating system (OS) used in a computer system does not support the memory redundancy function, the operation of the computer system needs to be stopped in order to replace a failed memory module operating in a critical situation where the FCC or ChipKill function has been activated due to failure.

The second problem is that a failed memory module incorporated in a memory system is unable to be replaced with a new memory module in the energized state where electric power is supplied to the memory system, in other words, a failed memory module is unable to be replaced with a new one unless the operation of a computer system using the memory system is stopped. This is because the conventional memory control technique directly assigns the memory addresses in the memory space to the memory modules used and therefore, the modules used are unable to be replaced during the energized or in-service state.

### SUMMARY OF THE INVENTION

According, an object of the present invention is to provide a redundant memory system that makes it possible to replace a failed one of memory modules incorporated into a memory system with a new memory module during the energized or in-service state even if the OS used in a computer system does not support the memory redundancy function.

Another object of the present invention is to provide a redundant memory system that makes it possible to replace dynamically a failed one of memory modules incorporated into a memory system with a new memory module according to the necessity even if the memory system is being energized.

Still another object of the present invention is to provide a memory controller that makes it possible to replace a failed one of memory modules incorporated into a memory system with a new memory module during the in-service state even if the OS used in a computer system does not support the memory redundancy function.

A further object of the present invention is to provide a memory controller that makes it possible to replace dynamically a failed one of memory modules incorporated into a memory system with a new memory module according to the necessity even if the memory system is being energized.

The above objects together with others not specifically mentioned will become clear to those skilled in the art from the following description.

According to a first aspect of the present invention, a redundant memory system is provided, which comprises:

memory slots;

memory modules for storing data, the modules being inserted into the respective slots; and

a memory controller connected to the slots and providing redundancy;

wherein the controller defines one of the modules as a parity memory and its remainder as data memories;

and wherein a first parity code is generated from desired data to be stored and written into the parity memory and the desired data are written into the respective data memories;

and wherein the desired data are read from the respective data memories and the first parity code is read from the parity memory to thereby conduct a parity check operation and an error correction operation of the desired data using the desired data and the first parity code, resulting in the redundancy.

With the redundant memory system according to the first aspect of the present invention, memory modules for storing data are inserted into respective slots. A memory controller for controlling the modules is connected to the slots and provides redundancy. Moreover, the controller defines one of the modules as a parity memory and the remainder thereof as data memories. A first parity code is generated from desired data to be stored and written into the parity memory and the desired data are written into the respective data memories. The desired data are read from the respective data memories while the first parity code is read from the parity memory to thereby conduct a parity check operation an error correction operation of the desired data using the desired data and the first parity code, resulting in the redundancy.

Accordingly, the memory controller controls the incorporated modules in such a way as to make an operation corresponding to a Redundant Array of Inexpensive Disks (RAID). Thus, a failed one of the memory modules incorporated into the memory system can be replaced with a new memory module during the energized or in-service state even if the OS (operating system) used in a computer system does not support the memory redundancy function.

In a preferred embodiment of the module according to the first aspect of the invention, the memory slots are capable of hot plugging or hot swapping operation, wherein a failed one of the memory modules is replaceable with a new memory module in an energized state of the memory system.

In another preferred embodiment of the module according to the first aspect of the invention, the controller generates a second parity code using the desired data read from respective data memories and then, compares the second parity code with the first parity code read from the parity memory. The parity check operation is conducted by comparing the second parity code with the first parity code, When one of the modules defined as the data memories is failed, the error correction operation of the desired data is conducted by reconfiguring the desired data read from the remaining non-failed data memories and the first parity data read from the parity memory.

According to a second aspect of the present invention, another redundant memory system is provided, which comprises:

n memory slots, where n is an integer greater than one;

n memory modules for storing data, the modules being inserted into the respective slots; and

a memory controller connected to the slots and providing redundancy;

wherein the controller comprises

n ECC/ChIPKILL circuits connected to the respective slots, for ECC code generation, error check, data reconfiguration, and ChipKill operation;

a parity-generation/check/reconfiguration circuit connected to the n ECC/CHIPKILL circuits, the parity-generation/check/reconfiguration circuit defining one of the n modules as a parity memory and its remainder as (n−1) data memories; wherein a first parity code is generated from desired data to be stored and written into the parity memory while the desired data are written into the respective (n−1) data memories and wherein a second parity code is generated from the desired data read from the (n−1) data memories and compared with the first parity code read from the parity memory, thereby conducting an error checking operation; and wherein when one of the (n−1) data memories is failed, the desired data is reconfigured using the first parity code and the (n−2) data memories other than the failed one; and

an error count circuit including a generation counter register for storing generation counts of ECC errors and ChipKill errors, and a comparator for comparing the generation counts with a threshold; wherein the comparator outputs an interrupt signal to the upper system when one of the generation counts exceeds the threshold.

With the redundant memory system according to the second aspect of the present invention, in the memory controller, n ECC/ChIPKILL circuits are connected to the respective slots, for ECC code generation, error check, data reconfiguration, and ChipKill operation.

Moreover, a parity-generation/check/reconfiguration circuit is connected to the n ECC/CHIPKILL circuits. The parity-generation/check/reconfiguration circuit defines one of the n modules as a parity memory and its remainder as (n−1) data memories. A first parity code is generated from desired data to be stored and written into the parity memory while the desired data are written into the respective (n−1) data memories. A second parity code is generated from the desired data read from the (n−1) data memories and compared with the first parity code read from the parity memory, thereby conducting an error checking operation. When one of the (n−1) data memories is failed, the desired data is reconfigured using the first parity code and the (n−2) data memories other than the failed one.

An error count circuit is further provided, which includes a generation counter register for storing generation counts of ECC errors and ChipKill errors, and a comparator for comparing the generation counts with a threshold. The comparator outputs an interrupt signal to the upper system when one of the generation counts exceeds the threshold.

Accordingly, the memory controller controls the n modules in such a way as to make an operation corresponding to a RAID. Thus, a failed one of the n modules incorporated into the memory system can be replaced with a new memory module during the energized or in-service state even if the OS (operating system) used in a computer system does not support the memory redundancy function.

In a preferred embodiment of the module according to the second aspect of the invention, the parity-generation/check/reconfiguration circuit has the function of:

deblocking the desired data to (n−1) parts of data;

generating the first parity code through an Exclusive OR operation of the (n−1) parts of data;

writing the (n−1) parts of data into the respective (n−1) data memories;

reading the (n−1) parts of data from the respective (n−1) data memories;

generating the second parity code through an Exclusive OR operation of the (n−1) parts of data read from the respective (n−1) data memories; and

comparing the second parity code with the first parity code to generate a result for error finding;

wherein when no error is found according to the result, the (n−1) parts of data read are blocked to reconstitute the desired data and output the said desired data;

and wherein when an error is found in one of the (n−1) parts of data read according to the result, the error is corrected using the first parity data and the remaining (n−2) parts of data other than the failed one, and the (n−1) parts of data read are blocked to reconstitute the desired data.

According to a third aspect of the present invention, a memory controller used for a memory system is provided. This memory controller comprises:

means for defining one of memory modules inserted into respective memory slots as a parity memory and its remainder as data memories;

means for generating a first parity code from desired data to be stored;

means for writing the desired data into the respective data memories and the first parity code into the parity memory; and

means for reading the desired data from the respective data memories and the first parity code from the parity memory to thereby conduct a parity check operation and an error correction operation of the desired data using the desired data and the first parity code, resulting in the redundancy.

With the memory controller according to the third aspect of the present invention, there are the same advantages as those of the redundant memory system according to the first aspect of the invention because of the same reason as explained in the redundant memory system according to the first aspect of the invention.

In a preferred embodiment of the controller according to the third aspect of the invention, the memory slots are capable of hot plugging or hot swapping operation, wherein a failed one of the memory modules is replaceable with a new memory module in an energized state of the memory system.

In another preferred embodiment of the controller according to the third aspect of the invention, a second parity code is generated using the desired data read from respective data memories and then, the second parity code is compared with the first parity code read from the parity memory. The parity check operation is conducted by comparing the second parity code with the first parity code. When one of the modules defined as the data memories is tailed, the error correction operation of the desired data is conducted by reconfiguring the desired data read from the remaining non-failed data memories and the first parity data read from the parity memory.

According to a fourth aspect of the present invention, another memory controller used for a memory system is provided. This memory controller comprises:

n ECC/ChIPKILL circuits connected to respective n memory slots, for ECC code generation, error check, data reconfiguration, and ChipKill operation, where n is an integer greater than one;

a parity-generation/check/reconfiguration circuit connected to the n ECC/CHIPKILL circuits, the parity-generation/check/reconfiguration circuit defining one of n memory modules as a parity memory and its remainder as (n−1) data memories; wherein a first parity code is generated from desired data to be stored and written into the parity memory while the desired data are written into the respective (n−1) data memories; and wherein a second parity code is generated from the desired data read from the (n−1) data memories and compared with the first parity code read from the parity memory, thereby conducting an error checking operation; and wherein when one of the (n−1) data memories is failed, the desired data is reconfigured using the first parity code and the (n−2) data memories other than the failed one; and

an error count circuit including a generation counter register for storing generation counts of ECC errors and ChipKill errors, and a comparator for comparing the generation counts with a threshold; wherein the comparator outputs an interrupt signal to the upper system when one of the generation counts exceeds the threshold.

With the memory controller according to the fourth aspect of the present invention, there are the same advantages as those of the redundant memory system according to the second aspect of the invention because of the same reason as explained in the redundant memory module according to the second aspect of the invention.

In a preferred embodiment of the controller according to the fourth aspect of the invention, the parity-generation/check/reconfiguration circuit has the function of:

deblocking the desired data to (n−1) parts of data;

generating the first parity code through an Exclusive OR operation of the (n−1) parts of data;

writing the (n−1) parts of data into the respective (n−1) data memories;

reading the (n−1) parts of data from the respective (n−1) data memories;

generating the second parity code through an Exclusive OR operation of the (n−1) parts of data read from the respecting (n −1) data memories; and

comparing the second parity code with the first parity code to generate a result for error finding;

wherein when no error is found according to the result, the (n−1) parts of data read are blocked to reconstitute the desired data and output the said desired data;

and wherein when an error is found in one of the (n−1) parts of data read according to the result, the error is corrected using the first parity data and the remaining (n−2) parts of data other than the failed one, and the (n−1) parts of data read are blocked to reconstitute the desired data

In the above-described redundant memory systems according to the first and second aspects of the invention and the above-described memory controllers according to the third and fourth aspects of the invention, there is an additional advantage that dynamic replacement of memory modules is possible even if the system is in service by using memory slots capable of the hot plugging operation according to the definition by the Joint Electron Device Engineering Council (JEDEC).

### BRIEF DESCRIPTION OF THE DRAWINGS

In order that the present invention may be readily carried into effect, it will now be described with reference to the accompanying drawings.

FIG. 1 is a functional block diagram showing the circuit configuration of a redundant memory system according to an embodiment of the invention.

FIG. 2 is a schematic diagram showing the parity code generation operation of the parity-generation/check/reconfiguration circuit used in the redundant memory system according to the embodiment of FIG. 1.

FIG. 3 is a schematic diagram showing the normal reading operation of the parity-generation/check/reconfiguration circuit used in the redundant memory system according to the embodiment of FIG. 1.

FIG. 4 is a schematic diagram showing the data-reconfiguration operation of the parity-generation/check/reconfiguration circuit used in the redundant memory system according to the embodiment of FIG. 1.

FIG. 5 is a schematic functional diagram showing the configuration of the error count register circuit used, in the redundant memory system according to the embodiment of FIG. 1.

FIG. 6 is a flowchart showing the power-on operation of the redundant memory system according to the embodiment of FIG. 1.

FIG. 7 is a flowchart showing the data writing operation of the redundant memory system according to the embodiment of FIG. 1.

FIG. 8 is a flowchart showing the data reading operation of the redundant memory system according to the embodiment of FIG. 1.

FIG. 9 is a flowchart showing the data reconfiguration operation of the redundant memory system according to the embodiment of FIG. 1.

### DETAILED DESCRIPTION OF THE PREFERRED EMBODIMENTS

Preferred embodiments of the present invention will be described in detail below while referring to the drawings attached.

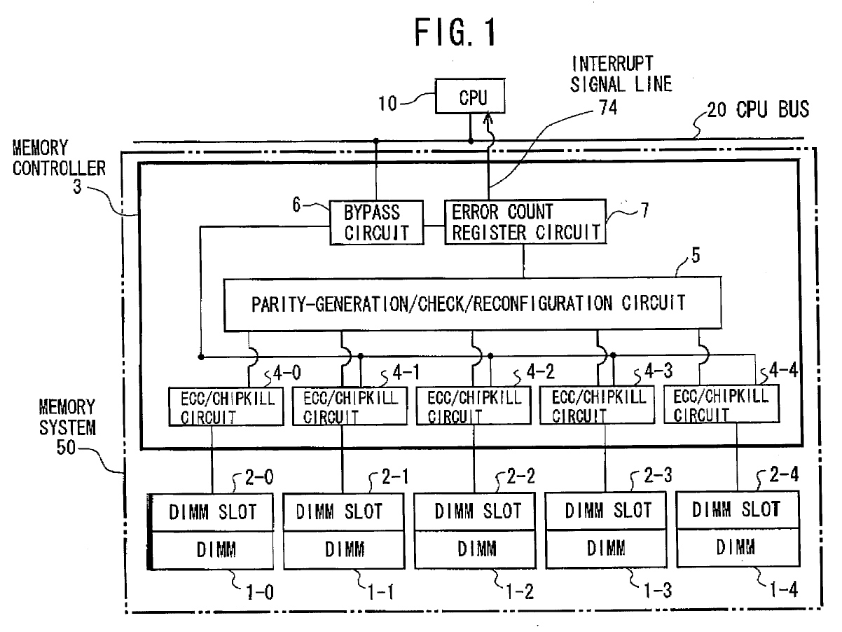

As shown in FIG. 1, a redundant-memory system 50 according to an embodiment of the invention comprises five DIMMs 1-0, 1-1, 1-2, 1-3, and 1-4, five DIMM slots 2-0, 2-1, 2-2, 2-3, and 2-4 receiving respectively the DIMMs 1-0, 1-1, 1-2, 1-3, and 1-4, and a memory controller 3 electrically connected to all the slots 2-0 to 2-4. Each of the DIMMs 1-0 to 1-4 serves as a memory module. The memory controller 3, which is used to control the entire operation of the memory system 50, is electrically connected to a Central Processing Unit (CPU) 10 by way of a CPU bus 20. The CPU 20 is an upper system of the system 50. All the DIMM slots 2-0 to 2-4 are capable of hot plugging operation according to the definition by JEDEC.

The memory controller 3 comprises five ECC/CHIPKILL circuits 4-0, 4-1, 4-2, 4-3, and 4-4, a parity generation/check/reconfiguration circuit 5, a bypass circuit 6, and an error count register circuit 7. According to the instruction from the CPU 10, the controller 3 controls the operations to write data into the respective DIMMs 1-0 to 1-4 inserted into the slots 2-0 to 2-4, to read the data from the respective DIMMs 1-0 to 1-4, and the other operations explained below.

The ECC/CHIPKILL circuits 4-0 to 4-4, which are electrically connected to the slots 2-0 to 2-4, respectively, conducts the operations of ECC (Error Checking and Correction) code generation, ECC check, and ECC data reconfiguration, and ChipKill error correction. The detailed configuration and operation of the ECC/CHIPKILL circuits 4-0 to 4-4 are well known and they do not relate to the invention. Therefore, no further explanation about them is presented here.

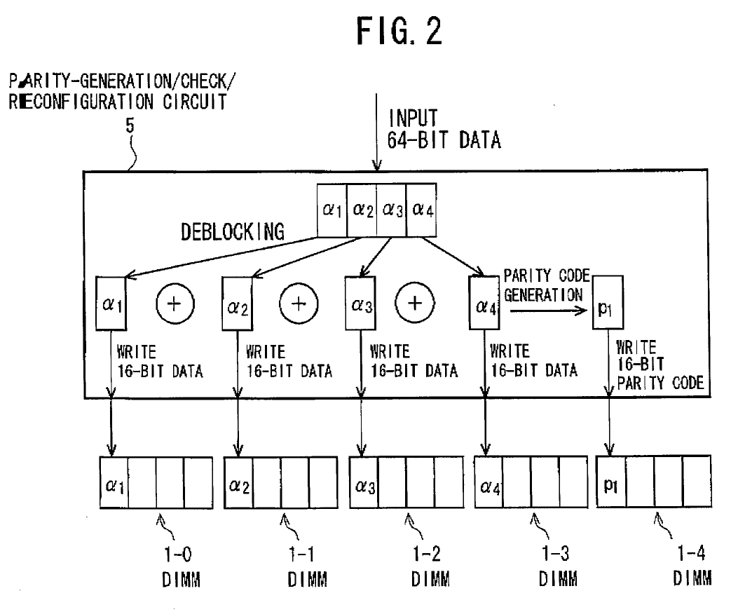

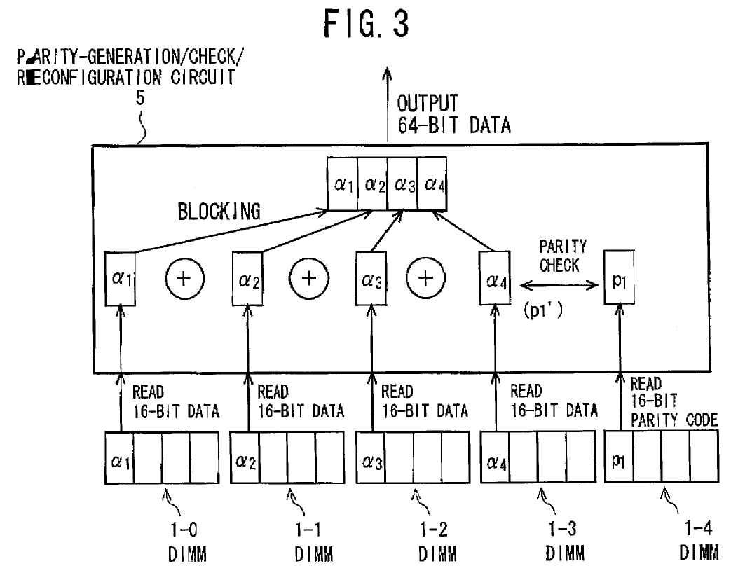

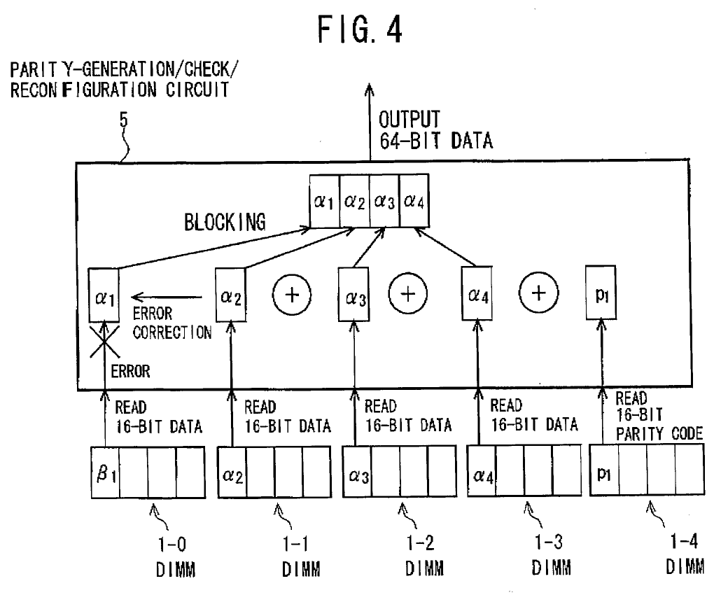

The parity-generation/check/reconfiguration circuit 5 is electrically connected to the ECC/CHIPKILL circuits 4-0 to 4-4. The circuit 5 defines one of the five DIMMs 1-0 to 1-4 as a parity memory and the remainder thereof as data memories. Here, the DIMM 1-4 is defined as the parity memory and the remaining four DIMMs 1-0 to 1-3 are defined as the data memories. Moreover, in the data writing operation, the circuit 5 divides input data into four parts of data and generates a first parity code from these parts of data. Then, the circuit 5 writes the four parts of data into the four data memories (i.e., the DIMM 1-0 to 1-3), respectively, and writes the first parity code into the parity memory (i.e., the DIMM 1-4) (see FIG. 2). In the data reading operation, the circuit 5 reads out the parts of data from the four data memories (DIMMs 1-0 to 1-3) and the first parity data from the parity memory (i.e., the DIMM 1-4). Then, the circuit 5 generates a second parity code by using the four parts of data read from the four data memories (DIMMs 1-0 to 1-3). Thereafter, the circuit 5 compares the first and second parity codes to each other, thereby conducting the parity check operation (see FIG. 3). If an error is found in one of the data memories in the said parity check operation, the circuit 5 conducts the error correction operation using the other parts of data store in the remaining three data memories and the first parity code (see FIG. 4), thereby recovering the part of data stored in the failed data memory (i.e., one of the DIMMs 1-0 to 1-3). Finally, the circuit 5 combines the four parts of data together to generate the correct input data.

The bypass circuit 6 is used to select one of the “RAIMM (or redundancy) mode” where the desired data is sent by way of the parity-generation/check/reconfiguration circuit 5, and the “bypass mode” where the desired data is sent to bypass the circuit 5 (i.e., sent without passing through the circuit 5) according to an instruction from the CPU 10.

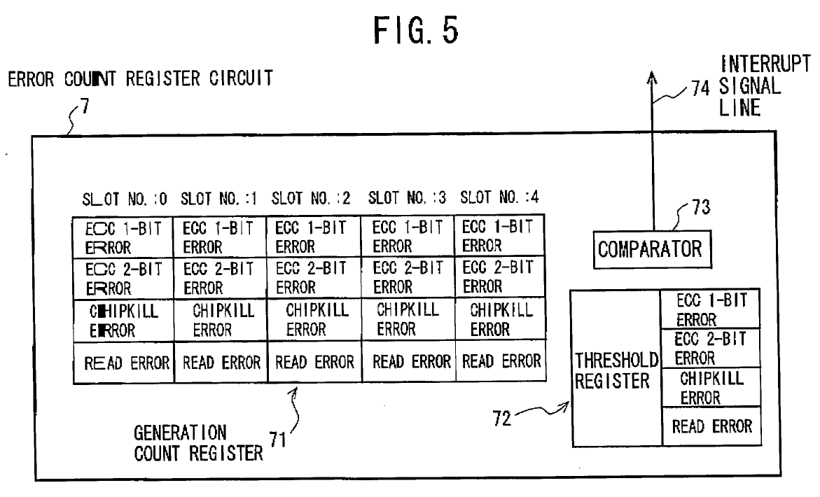

Referring to FIG. 5, the error count register circuit 7 includes a generation count register 71, a threshold register 72, a comparator 73, and an interrupt signal line 74.

The generation count register 71 is used to store the generation counts of ECC 1-bit errors, ECC 2-bit errors, ChipKill errors, and read errors. The threshold register 72 is used to store the threshold for ECC 1-bit errors, ECC 2-bit errors, ChipKill errors, and read errors. The comparator 73 compares the generation counts stored in the generation count register 71 and the threshold stored in the threshold counter 72 and then, outputs an interrupt signal if one of the counts stored in the generation count register 71 exceeds the threshold stored in the threshold counter 72. The interrupt signal line 74 is a line through which the interrupt signal from the comparator 73 is sent when one of the generation counts stored in the register 71 exceeds the threshold.

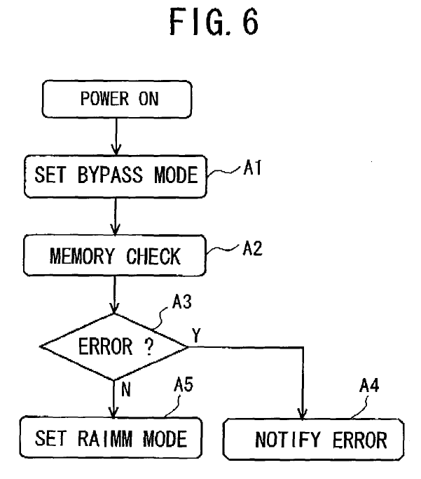

Referring to FIG. 6, the power-on operation of the memory system 50 according to the embodiment of the invention comprises the step A1 of setting the bypass mode, the step A2 of memory checking, the step A3 of error judgment, the step A4 of notifying the error to the operator or user of the system 50, and the step A5 of setting the RAIMM or redundancy mode.

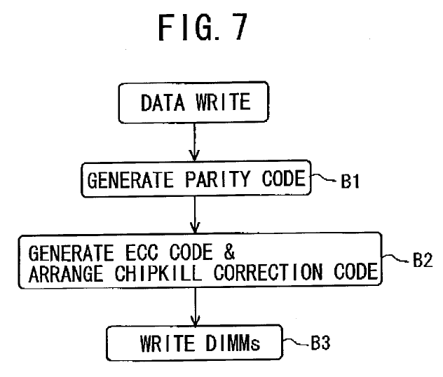

Referring to FIG. 7, the data writing operation of the memory system 50 according to the embodiment of the invention comprises the step B1 of generating the first parity code, the step B2 of generating an ECC code and arranging a ChipKill correction code, and the step B3 of writing the four parts of the input data into the four data memories and the first parity code into the parity memory, respectively.

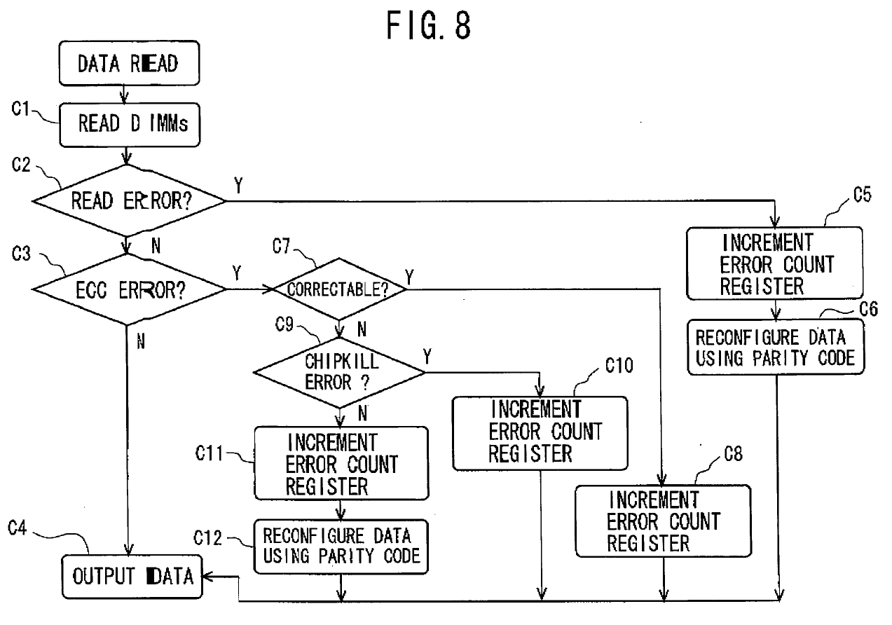

Referring to FIG. 8, the data reading operation of the memory system 50 according to the embodiment of the invention comprises the step C1 of reading the four parts of the data from the four data memories and the first parity code from the parity memory, the step C2 of judging the existence of a read error, the step C3 of judging the existence of an ECC error, the step C4 of outputting the data from the memory system 50, the step C5 of incrementing the generation count of the error count register circuit 1, the step C6 of reconfiguring the data using the parity code, the step C7 of judging whether the ECC error found is correctable, the step C8 of incrementing the generation count of the error count register circuit 7, the step C9 of judging the existence of a ChipKill error, the steps C10 and C11 of respectively incrementing the generation counts of the error count register circuit 7, and the step C12 of reconfiguring the data using the parity code.

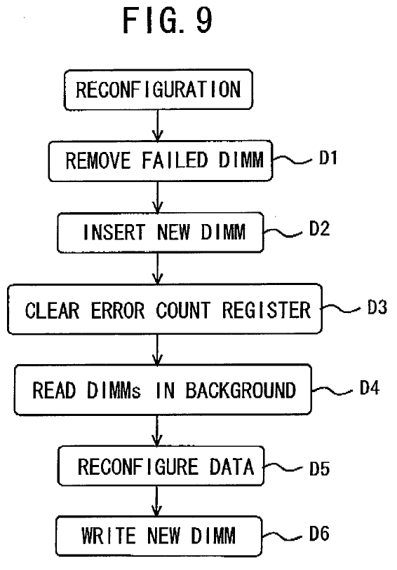

Referring to FIG. 9, the data reconfiguration operation of the memory system 50 according to the embodiment of the invention comprises the step D1 of removing a failed one of the incorporated DIMMs 1-0 to 1-5 (i.e., a failed one of the data and parity memories), the step D2 of inserting a new DIMM into the corresponding slot 2-0, 2-1, 2-2, 2-3, or 2-4, the step D3 of clearing all the counts of the generation count register 71 in the error count register circuit 7 to zero, the step D4 of reading the parts of the data and the parity code from the normal DIMMs 1-1 to 1-5 (i.e., the four data memories and the parity memory) in the background, the step D5 of reconfiguring the data using the parts of the correct data and the parity code thus read out, and the step D6 of writing the corresponding part of the data thus reconfigured into the new DIMM 1-0.

Next, the overall operation of the redundant memory system 50 according to the embodiment of the invention is explained in more detail below.

When the power is turned on, as shown in FIG. 6, the bypass circuit 6 is initially set to select the bypass mode (Step A1). Therefore, the CPU 10 conducts the initial memory check operation for all the DIMMs 1-0 to 1-4 without using the parity-generation/check/reconfiguration circuit 5 (Step A2). At this time, if an error is found in one of the DIMMs 1-0 to 1-4 (Step A3), the error is notified to the user or operator in a specific way according to the design of the computer system using the memory system 50 (Step A5) by, for example, displaying a specific error message on the display screen and emitting an error sound-If no error is found in all the DIMMs 1-0 to 1-4, in other words, the initial memory check is normally completed (Step A3), the CPU 10 instructs the bypass circuit 6 to switch from the bypass mode to the RAIMM or redundancy mode (Step A5).

When the data is written into the memory system 50 according to the embodiment of the invention, as shown in FIG. 7, the parity-generation/check/reconfiguration circuit 5 divides the input data into four parts of data and generates the first parity code from the four parts of data thus formed (Step B1). Then, the ECC/CHIPKILL circuits 4-0 to 4-4 generate the error correction code and arrange the ChipKill correction code for the DIMMs 1-0 to 1-4 (Step B2). Subsequently, the circuits 4-0 to 4-3 write the four parts of data into the respective DIMMs 1-0 to 1-3 (Step B3), while the circuit 4-4 writes the first parity code into the DIMM 1-4 (Step B3)

For example, as shown in FIG. 2, when the input data is 64-bit data, the parity-generation/check/reconfiguration circuit 5 deblocks the 64-bit input data, which are expressed by (α1+α2 +α3+α4), into the four 16-bit deblocked data (i.e., parts of data) α1, α2, α3, and α4 to be written respectively into the four DIMMs 1-0 to 1-3. On the other hand, the circuit 5 generates the 16-bit first parity code p1 through an Exclusive OR operation of the four parts of 16-bit data α1, α2, α3, and α4. Thereafter, the circuit 5 sends the parts of data α1, α2, α3, and α4 and the first parity code p1 thus generated to the five ECC/CHIPKILL circuits 4-0 to 4-4, respectively (Step B1). In response, the ECC/CHIPKILL circuits 4-0 to 4-4 generate the ECC code and arrange the ChipKill correction code (Step B2). Subsequently, the circuits 4-0 to 4-4 actually write the parts of data α1, α2, α3, and α4 into the corresponding DIMMs 1-0 to 1-3 and the first parity code p1 into the DIMM 1-4 (Step B3).

Next, when the input data is read from the memory system 50 according to the embodiment of the invention, as shown in FIG. 8, the memory controller 3 reads out the parts of the 16-bit data α1, α2, α3,and α4 from the respective DIMMs 1-0 to 1-3 and at the same time, the 16-bit first parity code p1 from the DIMM 1-4 (Step C1). Thereafter, the ECC/CHIPKILL circuits 4-0 to 4-4 judge whether a read error is found or not (Step C2).

When no read error is found in the Step C2, each of the circuits 4-0 to 4-4 judges whether an ECC error is found or not (Step C3). When no ECC error is found in the Step C3, the parity-generation/check/reconfiguration circuit 5 reconfigures or blocks the 16-bit parts of the data α1, α2, α3, and α4 thus read, thereby forming the 64-bit data (α1+α2+α3+α4) and outputting the same to the CPU 10 by way of the CPU bus 20 (Step C4). On the other hand, when an ECC error is found in the Step C3, the flow is jumped to the step C7 where the ECC error is judged correctable or not.

For example, as shown in FIG. 3, the parity-generation/check/reconfiguration circuit 5 reads the four 16-bit data α1, α2, α3,and α4 from the corresponding DIMMs 1-0 to 1-3, respectively, and reads the 16-bit first parity code from the DIMM 1-4 (Step C1). Thereafter, the circuit 5 blocks or combines the 16-bit data α1, α2, α3,and α4 together to reconstitute the 64-bit input data (60 1+α2+α3+α4). At this time, the circuit 5 generates a second parity code p1′ through an Exclusive OR operation of the four parts of the data α1, α2, α3,and α4 thus read. Thereafter, the circuit 5 compares the second parity code p1′ thus generated with the first parity code p1 read from the DIMM 1-4. If the circuit 5 judges that no parity error exists at this time through the comparison of the first and second parity codes, the 64-bit input data (α1+α2+α3+α4) thus reconstituted are judged correct, and outputted to the CPU 10 by way of the CPU bus 20 (Step C4).

On the other hand, when a read error is found in one of the DIMMs 1-0 to 1-4 in the Step C2, the memory controller 3 increments the generation count of the read error in the generation count register 71 of the error count register 7 (Step C5) Thereafter, the parity-generation/check/reconfiguration circuit 5 reconfigures the 16-bit data α1, α2, α3, and α4 thus read using the first parity code p1, thereby forming the 64-bit correct data (α1+α2+α3+α4) (Step C6). The circuit 5 outputs the 64-bit data (α1+α2+α3+α4) thus generated toward the CPU 10 by way of the CPU bus 20 (Step C4).

For example, as shown in FIG. 4, it is supposed that the parity-generation/check/reconfiguration circuit 5 judges a correctable 1-bit error exists in the 16-bit faulty sub-data B1 read from the DIMM 1-0 (which corresponds to the slot No. 1) (Step C2). In this case, the circuit 5 generates the 16-bit correct data α1 through an Exclusive OR operation of the 16-bit data α2, α3, and α4 and the 16-bit first parity code p1. Thereafter, the circuit 5 blocks or combines the data al thus generated with the data α2, α3, and α4, thereby reconstituting the 64-bit data (α1+α2+α3 +α4) (Step C6). Then, the circuit 5 outputs the 64-bit data (α1 +α2+α3+α4) thus obtained toward the CPU 10 by way of the CPU bus 20 (Step C4).

When the ECC error found in the step C3 is judged correctable (Step C7), the memory controller 3 increments the generation count of the ECC 1-bit error of the generation count register 71 in the error count register 7 (Step C8). The ECC 1-bit error is corrected by a corresponding one the ECC/CHIPKILL circuits 4-0 to 4-4. Thereafter, the parity-generation/check/reconfiguration circuit 5 reconfigures the 16-bit data α1, α2, α3,and α4 thus corrected, thereby forming the 64-bit data (α1+α2+α3+α4). The circuit 5 outputs the 64-bit data (α1+α2+α3+α4) toward the CPU 10 by way of the CPU bus 20 (Step C4).

When the ECC error found in the step C3 is judged non-correctable (Step C7), the corresponding one of the ECC/CHIPKILL circuits 4-0 to 4-4 judges whether the said error is correctable by the ChipKill correction operation (Step C9). When the error is judged correctable by the ChipKill correction operation in the step C9, the parity-generation/check/reconfiguration circuit 5 increments the generation count of the ChipKill error of the generation count register 71 in the error count register 7 (Step C10). Thereafter, the circuit 5 reconfigures the 16-bit sub-data α1, α2, α3, and α4 thus corrected, thereby forming the 64-bit data (α1+α2+α3+α4). The circuit 5 outputs the 64-bit data (α1+α2+α3+α4) toward the CPU 10 by way of the CPU bus 20 (Step C4).

When the error is judged non-correctable by the ChipKill correction operation in the step CD, the memory controller 3 increments the generation count of the 2-bit error of the generation count register 71 in the error count register 7 (Step C11). Thereafter, the circuit 5 reconfigures the 16-bit data α1, α2, α3, and α4 using the first parity code, thereby forming the 64-bit data (α1+α2+α3+α4) (Step C12). The circuit 5 outputs the 64-bit data (α1+α2+α3+α4) thus formed toward the CPU 10 by way of the CPU bus 20 (Step C4).

When one of the generation counts of the ECC 1-bit error, the ECC 2-bit error, the ChipKill error, and the read error of the generation counter 71 for the DIMM slots 2-0 to 2-4 (i.e., the slot Nos. 0, 1, 2, 3, and 4) exceeds the predetermined threshold value in the threshold counter 72 through the comparison operation of the comparator 73, the comparator 73 of the error count register circuit 7 outputs an interrupt signal to the CPU 10 by way of the interrupt signal line 74.

In the following explanation, it is supposed that one of the generation counts of the ECC 1-bit error, the ECC 2-bit error, the ChipKill error, and the read error of the generation counter 71 for the DIMM slot 2-0 (i.e., the slot No. 0, the DIMM 1-0) has exceeded the predetermined threshold value in the threshold counter 72.

When the CPU 10 receives the interrupt signal from the error count register circuit 7, a predetermined fault detection alarm is emitted to the operator of the computer system. The alarm contains some information identifying the slot No. where the fault has occurred, in other words, one of the generation counts of the generation counter 71 has exceeded the predetermined threshold value stored in the threshold register 72.

In response to the fault detection alarm thus emitted, the operator knows the occurrence of the fault in the memory system 50 and the faulty slot No. Then, the operator removes the faulty DIMM 1-0 from the corresponding slot 2-0 (Step D1). While the DIMM 1-0 is being removed from the slot 2-0, the memory controller 3 treats the state like a read error has occurred in the slot 2-0, in which the steps C2, C5, C6, and C4 in FIG. 8 are carried out.

Subsequently, a new, normal DIMM is inserted into the slot 2-0 (Step D2). At this time, in response to this insertion, the memory controller 3 clears the generation counts of the ECC 1-bit error, the ECC 2-bit error, the ChipKill error, and the read error of the generation counter 71 for the DIMMs 1-0 to 1-4. In other words, the controller 3 assigns the value of zero to the respective counts of the counter 71 (Step D3). Then, in the background of the access of the CPU 10, the parity-generation/check/reconfiguration circuit 5 reads the parts of the 16-bit correct data α2, α3, and α4 from the three normal QIMMs 1-1 to 1-3, respectively, and the 16-bit first parity code p1 from the normal DIMM 1-4 (Step D4). Thereafter, the circuit 5 reconfigures the 16-bit data al using the other 16-bit data α2, α3, and α4 and the parity code p1 (Step D5) and then, writes the correct data α1 thus obtained into the newly-inserted DIMM 1-0 (Step D6).

In this way, the four parts of the correct data ail, α2, α3, and α4 and the parity code p1 are written into the normal DIMMs 1-0 to 1-4, respectively. This means that the 16-bit data (α1, α2, α3, and α4 and the parity code pi are equal to those written in the respective DIMMs 1-0 to 1-4 before the fault occurred. As a result, the data stored in the redundant memory system 50 according to the embodiment of the invention can be recovered, even if all the slots 2-0 to 2-4 are being energized, i.e., electric power is being supplied to the system 50.

It is supposed that a correctable 1-bit error exists in the 16-bit faulty sub-data B1 from the DIMM 1-0 (i.e., the slot No. 1) in the above-described embodiment. However, it is needless to say that the same operation as above is carried out when an error exists in one of the other DIMMs 1-1 to 1-4.

With the redundant memory system 50 according to the embodiment of the invention, as explained above in detail, the following advantages are obtainable.

(i) Redundancy can be given to the DIMMs 1-0 to 1-4, because the parts of the data α1, α2, α3,and α4 and the parity code p1 are generated from the input data (α1+α2+α3+α4), and the correct data α1, α2, α3,and α4 can be recovered using the parity code p1 as necessary.

(ii) A failed one of the DIMMs 1-0 to 1-4 (i.e., the memory modules) is replaceable with a new one during the in-service state even if the OS used in the computer system does not support the memory redundancy function. This is because the reading and writing operations can be carried out in the memory space where the OS is operating even if one of the DIMMs 1-0 to 1-4 is failed.

(iii) Dynamic replacement of the DIMMs 1-0 to 1-4 is realizable during the in-service or energized state by simply using hot-plugging DIMM slots according to the definition by JEDEC.

(iv) The system availability is improved because dynamic replacement of the DIMMs 1-0 to 1-4 is realizable.

### VARIATIONS

It is needless to say that the invention is not limited to the above-described embodiment. Any modification is applicable to the embodiment. For example, the memory modules used in the above embodiment are in the form of the DIMM. However, any other form (e.g., SIMM) of memory modules may be used if it is replaceable in the energized state of a computer system.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A redundant memory system comprising:
memory slots;
memory modules for storing data, the modules being inserted into the respective slots; and
a memory controller connected to the slots and providing redundancy;
wherein the controller defines one of the modules as a parity memory and its remainder as data memories;
and wherein a first parity code is generated from desired data to be stored and written into the parity memory and the desired data are written into the respective data memories;
and wherein the desired data are read from the respective data memories and the first parity code is read from the parity memory to thereby conduct a parity check operation and an error correction operation of the desired data using the desired data and the first parity code, resulting in the redundancy.

2. The memory system according to claim 1, wherein the memory slots are capable of hot plugging or hot swapping operation, wherein a failed one of the memory modules is replaceable with a new memory module in an energized state of the memory system.

3. The memory system according to claim 1, wherein the controller generates a second parity code using the desired data read from respective data memories and then, compares the second parity code with the first parity code read from the parity memory;
and wherein the parity check operation is conducted by comparing the second parity code with the first parity code;
and wherein when one of the modules defined as the data memories is failed, the error correction operation of the desired data is conducted by reconfiguring the desired data read from the remaining non-failed data memories and the first parity data read from the parity memory.

4. A redundant memory system comprising:
n memory slots, where n is an integer greater than one;
n memory modules for storing data, the modules being inserted into the respective slots; and
a memory controller connected to the slots and providing redundancy;
wherein the controller comprises
n ECC/ChIPKILL circuits connected to the respective slots, for ECC code generation, error check, data reconfiguration, and ChipKill operation;
a parity-generation/check/reconfiguration circuit connected to the n ECC/CHIPKILL circuits, the parity-generation/check/reconfiguration circuit defining one of the n modules as a parity memory and its remainder as (n−1) data memories; wherein a first parity code is generated from desired data to be stored and written into the parity memory while the desired data are written into the respective (n−1) data memories; and wherein a second parity code is generated from the desired data read from the (n−1) data memories and compared with the first parity code read from the parity memory, thereby conducting an error checking operation; and wherein when one of the (n−1) data memories is failed, the desired data is reconfigured using the first parity code and the (n−2) data memories other than the failed one; and
an error count circuit including a generation counter register for storing generation counts of FCC errors and ChipKill errors, and a comparator for comparing the generation counts with a threshold; wherein the comparator outputs an interrupt signal to the upper system when one of the generation counts exceeds the threshold.

5. The memory system according to claim 4, wherein the parity-generation/check/reconfiguration circuit has the function deblocking the desired data to (n−1) parts of data; of;
generating the first parity code through an Exclusive OR operation of the (n−1) parts of data;
writing the (n−1) parts of data into the respective (n−1) data memories;
reading the (n−1) parts of data from the respective (n−1) data memories;
generating the second parity code through an Exclusive OR operation of the (n−1) parts of data read from the respective (n −1) data memories; and
comparing the second parity code with the first parity code to generate a result for error finding;
wherein when no error is found according to the result, the (n−1) parts of data read are blocked to reconstitute the desired data and output the said desired data;
and wherein when an error is found in one of the (n−1) parts of data read according to the result, the error is corrected using the first parity data and the remaining (n−2) parts of data other than the failed one, and the (n−1) parts of data read are blocked to reconstitute the desired data.

6. A memory controller comprising:
means for defining one of memory modules inserted into respective memory slots as a parity memory and its remainder as data memories;
means for generating a first parity code from desired data to be stored;
means for writing the desired data into the respective data memories and the first parity code into the parity memory; and
means for reading the desired data from the respective data memories and the first parity code from the parity memory to thereby conduct a parity check operation and an error correction operation of the desired data using the desired data and the first parity code, resulting in the redundancy.

7. The memory controller according to claim 6, wherein the memory slots are capable of hot plugging or hot swapping operation, wherein a failed one of the memory modules is replaceable with a new memory module in an energized state of the memory system.

8. The memory controller according to claim 6, wherein a second parity code is generated using the desired data read from respective data memories and then, the second parity code is compared with the first parity code read from the parity memory;
and wherein the parity check operation is conducted by comparing the second parity code with the first parity code;
and wherein when one of the modules defined as the data memories is failed, the error correction operation or the desired data is conducted by reconfiguring the desired data read from the remaining non-failed data memories and the first parity data read from the parity memory.

9. A memory controller comprising:
n ECC/ChIPRILL circuits connected to respective n memory slots, for ECC code generation, error check, data reconfiguration, and ChipKill operation, where n is an integer greater than one;
a parity-generation/check/reconfiguration circuit connected to the n ECC/CHIPKILL circuits, the parity-generation/check/reconfiguration circuit defining one of n memory modules as a parity memory and its remainder as (n−1) data memories; wherein a first parity code is generated from desired data to be stored and written into the parity memory while the desired data are written into the respective (n−1) data memories; and wherein a second parity code is generated from the desired data read from the (n−1) data memories and compared with the first parity code read from the parity memory, thereby conducting an error checking operation; and wherein when one of the (n−1) data memories is failed, the desired data is reconfigured using the first parity code and the (n−2) data memories other than the failed one; and
an error count circuit including a generation counter register for storing generation counts of ECC errors and ChipKill errors, and a comparator for comparing the generation counts with a threshold; wherein the comparator outputs an interrupt signal to the upper system when one of the generation counts exceeds the threshold.

10. The memory controller according to claim 9, wherein the parity-generation/check/reconfiguration circuit has the function of:
deblocking the desired data to (n−1) parts of data;
generating the first parity code through an Exclusive OR operation of the (n−1) parts of data;
writing the (n−1) parts of data into the respective (n−1) data memories;
reading the (n−1) parts of data from the respective (n−1) data memories;
generating the second parity code through an Exclusive OR operation of the (n−1) parts of data read from the respective (n −1) data memories; and
comparing the second parity code with the first parity code to generate a result for error finding;
wherein when no error is found according to the result, the (n−1) parts of data read are blocked to reconstitute the desired data and output the said desired data;
and wherein when an error is found in one of the (n−1) part of data read according to the result, the error is corrected using the first parity data and the remaining (n−2) parts of data other than the failed one, and the (n−1) parts of data read are blocked to reconstitute the desired data.
